(19) United States
(12) Patent Application Publication
(10) Pub. No.: US 2021/0206641 A1
(43) Pub. Date: Jul. 8, 2021

(54) METHOD FOR NITROGEN-DOPED GRAPHENE PRODUCTION

(71) Applicant: YUKSEL YENILENEBILIR ENERJI ANONIM SIRKETI, Istanbul (TR)

(72) Inventors: Edip BAYRAM, Antalya (TR); ZEHRA KURU, Antalya (TR); Cagdas KIZIL, Antalya (TR)

(73) Assignee: YUKSEL YENILENEBILIR ENERJI ANONIM SIRKETI, Istanbul (TR)

(21) Appl. No.: 17/056,003

(22) PCT Filed: Oct. 22, 2019
(86) PCT No.: PCT/TR2019/050884

§ 371 Date: Nov. 17, 2020

(30) Foreign Application Priority Data
Dec. 12, 2018 (TR) 2018/19187

(51) Int. Cl. C01B 32/184

(52) U.S. Cl. CPC C01B 32/184; B82Y 30/00

(57) ABSTRACT

A production method of nitrogen-doped graphene and silicon- and iron-doped graphene is provided. The production method includes the stages of preparing the mixture, the solvothermal process in the heat- and pressure-controlled reactor, preparing the liquid mixture out of the solid product, drying the mixture, and the pyrolysis of the dried product in order to obtain a final graphene-based product in which the particle size can be adjusted by adjusting the pH values of the liquid mixture within the range of 1-14 in one of the production steps.

### CROSS REFERENCE TO THE RELATED APPLICATIONS

This application is the national phase entry of International Application No. PCT/TR2019/050884, filed on Oct. 22, 2019, which is based upon and claims priority to Turkish Patent Application No. 2018/19187, filed on Dec. 12, 2018, the entire contents of which are incorporated herein by reference.

### TECHNICAL FIELD

The present invention relates to a method of producing a nitrogen-doped graphene (N-GN) and silicon- or iron-doped graphene in addition to the nitrogen, which may be used as anodes in lithium-ion batteries, as cathodes in the metal-air batteries, and as both anodes and cathodes in the supercapacitors.

### BACKGROUND

The graphene is an allotrope of carbon with a planar form created from the covalent bonded atoms of the carbon. The graphene is considered as one of the materials having the highest mechanical strength today. The graphene is used in various fields because of its flexibility, transparency, lightness, and high heat and electrical conductivity as well as the mechanical strength.

One of the fields in which the graphene is used is the energy storage systems. In the electrochemical energy storage systems such as Li-ion, metal-air, and supercapacitors, the carbon-based materials, particularly graphenes are used as the electrode material, because of their high surface areas and electrical conductivity, controllable pore structures, resistance to corrosion and also because they are cheap and can be readily supplied.

Graphene is different from the other carbon-based materials because of its extra-ordinary features. The nitrogen-doped graphene (N-GN) is obtained by doping the nitrogen atoms that are much more electronegative than the carbon to the graphene backbone. By doping nitrogen atoms to the structure, a higher electrical conductivity is obtained by increasing the electron density of the graphene by the unpaired electrons of the nitrogen atoms.

Also, the nitrogen loads the neighboring carbon atoms with partial positive charge because it is more electronegative than carbon, thereby facilitating the oxygen in the environment to be adsorbed by these carbon atoms and the oxygen which is difficult to be reduced to be transformed into oxyanions. By this process, the nitrogen-doped graphene may be used as the cathode electrocatalyst for the fuel cells and metal-air batteries. Also, the nitrogen atoms increase the specific capacitance value of the graphene in the aqueous electrolytes upon participating in the reversible redox reactions with electrolyte. However, the obstacles for producing cheap, pure, and perfect nitrogen-doped graphene in large amounts limit these applications.

There are currently various methods used for the production of nitrogen-doped graphene. One of these methods is the chemical vapor deposition method. In this method, small molecules containing nitrogen such as ammonia or hydrazine as the nitrogen source and the methane gas (CH₄) as the carbon source are passed over the nickel (Ni) catalyst coated on the silica (SiO₂/Si) layer at a high temperature, thereby producing the nitrogen-doped graphene. In this method, the formation of carbon-carbon bond occurs in the presence of the nickel catalyst. It is hard to remove the obtained nitrogen-doped graphene (N-GN) from the nickel catalyst because of the high solubility of the carbon in these metals, and it requires additional processes. Moreover, the method is not suitable for the industrial-scale nitrogen-doped graphene production.

Another method used presently is Hummers or modified Hummers methods through which the graphite-based nitrogen-doped graphene is obtained. In this method, the graphene oxide (GO) is produced of the graphite. Then, the nitrogen-doped graphene is produced in the form of dry mixture or aqueous/organic solutions with the nitrogen-containing organic molecules, such as graphene oxide (GO), melamine, cyanuric acid, dicyanamide, by applying any one of the processes such as solvothermal, ball mill, high temperature pyrolysis. By this approach, various methods are developed by using the combinations of the production steps and it is among the most common methods in the literature. The approach is expensive and time-consuming because it includes the production of the graphene oxide. Also, the fact that the graphene oxide comprises different oxygen functional groups results in the defects in the structure during the high temperature process. As a consequence, the common disadvantages of said methods are that the performance of the obtained electrode is low, it does not give repeatable results, and the nitrogen-doped graphene has a low specific surface area.

In the solvothermal method, the production of nitrogen-doped graphene is realized in one step at 250° C. by using lithium nitride (Li₃N) and tetrachloromethane (CCI₄). The graphene obtained through this method has a low layer number within the range of 1-6 and a nitrogen proportion within the range of 4.1-16.4%. It is a disadvantage of the method that the chemicals used are expensive and toxic although the method allows for the nitrogen-doped graphene production in one step.

Another method used is the ball mill method. In this method, graphite powder is used as the carbon source and the melamine which is a cheap industrial molecule is used as the nitrogen source; and the nitrogen-doped graphene production is realized in one step. The reaction occurs by removing the graphite layers upon turning the balls placed into the steel containers in 500 rpm for 48 hours and by adding the nitrogen into the graphene structure. Although this method is suitable for the industrial-scale production, it is the disadvantage of the method that the multi-layer graphene with low surface area is produced by the method. Agglomeration of the graphene plates again by the strong π-π interactions and the van der Waals forces reduces the total electrochemical surface area.

Another method which is currently used for the direct synthesis of the nitrogen-doped graphene is the arc discharge method for the graphite electrode in the presence of the precursor molecule comprising nitrogen. This method is disadvantageous because it requires specific equipment and high energy.

### SUMMARY

The object of the invention is to allow for obtaining the final graphene-based product in which the particle size can be adjusted upon adjusting the pH value of the mixture within the range of 1-14 at one of the production steps after the solvothermal process. Thus;
a graphene product is obtained with
high electrical conductivity,
high electrocatalytic activity,
uniform pore structure, and
with a structure in which the particle sizes can be adjusted.

Another object of the invention is to allow for obtaining graphene with the doping of silicon and/or iron atoms as well as the nitrogen.

Another object of the invention is to allow for producing the nitrogen-doped graphene having the suitable features for the application field since the pH value and thus the particle sizes can be controlled, by using the same system.

Another object of the invention is to allow for producing the nitrogen-doped graphene with high product efficiency in industrial scale compared to the present methods.

### BRIEF DESCRIPTION OF THE DRAWINGS

FIG. 1. N₂ adsorption/desorption isotherm of the nitrogen-doped graphene which is obtained by the method.

FIG. 2. BJH pore size distribution graph of the nitrogen-doped graphene obtained by the method and the BET report calculated with N₂ adsorption/desorption data.

FIG. 3. XRD spectrum obtained for the nitrogen-doped graphene (N-GN).

FIG. 4. Raman spectrum obtained for the nitrogen-doped graphene (N-GN).

FIG. 5. XPS spectrum obtained for the nitrogen-doped graphene (N-GN).

FIG. 6. High resolution C1S-XPS spectrum for the nitrogen-doped graphene.

FIG. 7. The charge-discharge curves of the nitrogen-doped graphene electrodes obtained by the method in the two-electrode cell performed in the solution containing 3.0 M H₂SO₄ electrolyte at different current densities.

FIG. 8. The charge-discharge curves of the nitrogen-doped graphene electrodes obtained in the solution containing 6.0 M KOH electrolyte at different current densities.

FIG. 9. The cyclic voltammetry voltammograms (CV) of the nitrogen-doped graphene obtained by the method in 0.1 M KOH electrolyte saturated with 02 and Ar gases at 20 mV/s potential scan rate.

FIG. 10. The specific capacity values of the batteries produced by using Li anode and different nitrogen-doped graphene-based cathodes obtained by the method provided at a current density of 0.01 A/g.

FIG. 11. The particle size view of the nitrogen-doped graphene obtained at pH>7 or pH<7.

### DETAILED DESCRIPTION OF THE EMBODIMENTS

The nitrogen-doped graphene (N-GN) is obtained by doping the nitrogen atoms that are much more electronegative than the carbon to the graphene backbone. By doping the nitrogen atoms to the structure, a higher electrical conductivity is obtained by increasing the electron density of the graphene by the unpaired electrons of the nitrogen atoms. Thus, the neighboring carbon atoms are loaded with partial positive charge since the nitrogen is more electronegative than carbon and the oxygen which is difficult to be reduced is transformed into oxyanions by facilitating the oxygen in the environment to be adsorbed by these carbon atoms.

The final graphene-based product can be obtained by the nitrogen-doped graphene production method of the invention in which the particle size can be adjusted upon adjusting the pH value of the mixture within the range of 1-14 at one of the production steps. The pH value of said mixture within the range of 1-14 is adjusted at one of the steps after the solvothermal process of the production method.

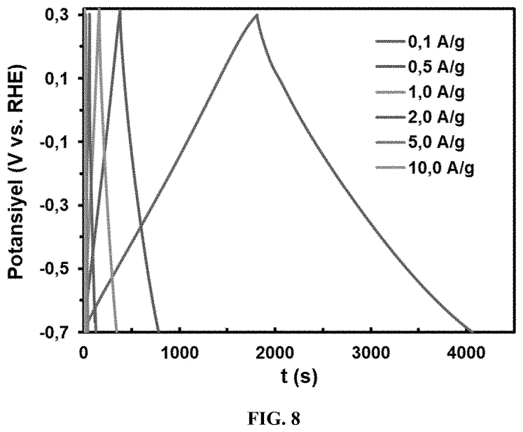

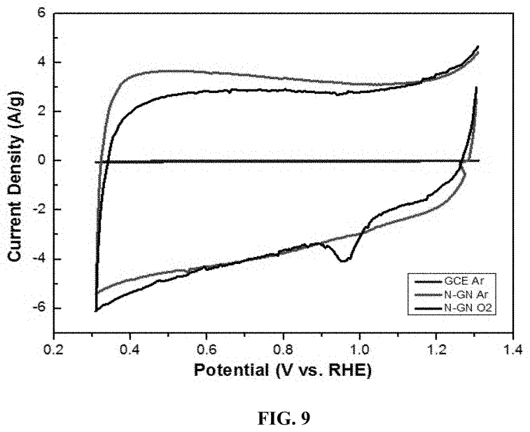

Referring to FIG. 8, the particle sizes of the nitrogen-doped graphene is smaller than 200 nm when the pH value of the graphene is higher than 7; and the particle sizes of the nitrogen-doped graphene is bigger than 200 nm when the pH value of the graphene is less than 7.

When the pH value of the nitrogen-doped graphene obtained is higher than 7, the nitrogen-doped graphene is obtained with the particle sizes smaller than 200 nm, and therefore the obtained product has higher porosity and thus higher electrochemical surface area.

The production method of the nitrogen-doped graphene as stated above consists of the stages of preparing the mixture, the solvothermal process in the temperature and pressure controlled reactor, preparing the liquid mixture out of the solid product, adjusting the pH value of the mixture, drying the mixture, and the pyrolysis of the dried product.

The first stage of the production method is the preparation of the mixture. At this stage, the metallic sodium (Na) and the carbon (C) source organic solvent which constitute the mixture are brought together.

Said mixture is prepared by introducing 1-50% metallic sodium (Na) by mass and 50-99% N,N-dimethylformamide (DMF) by mass within a chamber having a teflon surface.

The organic and/or inorganic compounds of silicon (Si), iron (Fe), and the other elements may be doped to the mixture at this stage.

The organic and/or inorganic compounds of other elements to be introduced may be introduced to the mixture so as to be 0.1-10% silicon (Si) and iron (Fe) atoms by total mass.

The stage of solvothermal process comes after preparing the mixture. At this stage, the prepared mixture is placed into the temperature and pressure controlled solvothermal reactor. The mixture is processed at a temperature of 70° C.-210° C. for 12 hours-60 hours. During the process, the pressure of the reactor is within the range of 10 bar-90 bar.

The ideal application of the solvothermal process is realized at a temperature of 190° C. with 60 bar reactor pressure for 48 hours. After the solvothermal process applied for the mixture, the next step is preparing liquid mixture of the solid product. Purified water or mineral acid solutions such as hydrochloric acid (HCl), sulfuric acid (H₂SO₄), perchloric acid (HClO₄) are introduced, and the mixture is liquefied such that the final pH value thereof will be within the range of 1-14.

The liquid mixture which has the appropriate pH value is introduced into the drying stage. At this stage, the liquid comprised by the mixture is removed by a heat treatment. The liquid mixture is dried in a vacuum oven at 80° C.-160° C., preferably 140° C.

After drying the liquid mixture, it is introduced into the pyrolysis stage. The dried mixture is pyrolyzed at this stage in the presence of argon (Ar), nitrogen (N₂), water (H₂O), or a combination thereof at a temperature of 450° C.-900° C. The ideal application of the pyrolysis process is carried out in the Argon (Ar) atmosphere at 750° C.

The particle sizes of N-GN obtained by this method at pH<7 is higher than 200 nm. Large particle sizes result in the reduced total electrochemical surface area by agglomeration of the N-GN plates again by the effect of strong π-π interactions and the Van der Waals forces.

The particle sizes of the nitrogen-doped graphene obtained at pH>7 are smaller than 200 nm. Thus, the obtained product has higher porosity and therefore higher electrochemical surface area. By the production method of the invention, the nitrogen-doped graphene may be produced by using the same system for different application fields because the final pH value and therefore the particle sizes and the product properties are controllable.

The production method of the final graphene-based product in which the particle size can be adjusted upon adjusting the pH value of the mixture within the range of 1-14 at one of the production steps after the solvothermal process comprises the following steps:
preparing the mixture by introducing 1-50% metallic sodium (Na) by mass and 50-99% N,N-dimethylformamide (DMF) by mass within a chamber having a teflon surface,
placing the prepared mixture into the temperature and pressure controlled solvothermal reactor,
subjecting the mixture placed into the heat- and pressure-controlled solvothermal reactor to the solvothermal process at a temperature of 70° C.-210° C. and at a reactor pressure within the range of 10 bar-90 bar for 12 hours-60 hours,
liquefying the mixture by adding purified water or mineral acid solutions such as hydrochloric acid (HCl), sulfuric acid (H₂SO₄), perchloric acid (HClO₄) such that the final pH value thereof will be within the range of 1-14,
drying the liquid mixture having a pH value within the range of 1-14 in a vacuum oven at a temperature of 80° C.-160° C.,
pyrolyzing the dried mixture in the presence of argon (Ar), nitrogen ((N₂), water (H₂O), or a combination thereof at a temperature of 450° C.-900° C. in the horizontal quartz-tube furnace,

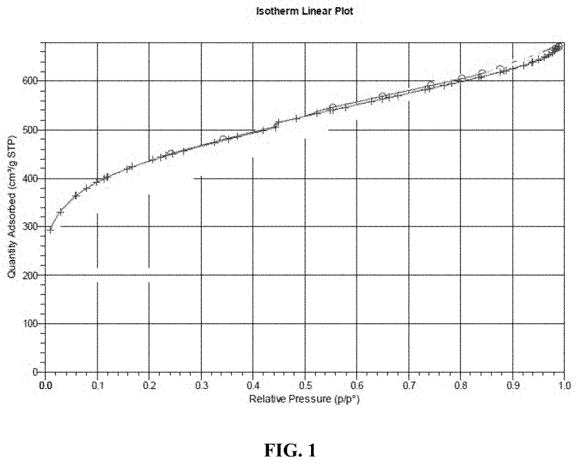

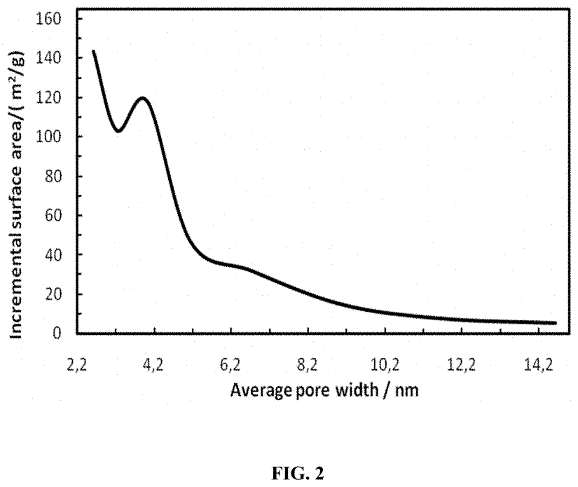

N₂ adsorption/desorption isotherm of the nitrogen-doped graphene obtained by the method of the invention is given in FIG. 1. BJH pore size distribution graph of the nitrogen-doped graphene obtained by the method of the invention and the BET report calculated with N₂ adsorption/desorption data is given in FIG. 2.

Total surface area is calculated as 1562 m²/g upon processing the data obtained from the N₂ adsorption/desorption isotherms for N-GN according to BET theory. The fact that no hysteresis is observed between the isotherms at Type IV view and the adsorption/desorption isotherms of FIG. 1 proves that N-GN has a mesoporous structure, with reference to FIG. 2. Also, about 51% of the total surface area of N-NG consists of the mesopores the pore sizes of which have the values of 2.6 nm and 15 nm.

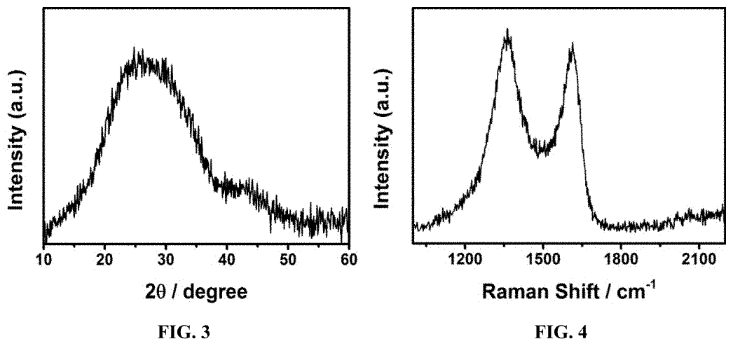

XRD spectrum obtained for the nitrogen-doped graphene (N-GN) is given in FIG. 3. It is an indication of the graphene plates became distant to each other that the sharp peak observed at about 20=26.5° which is characteristic for the graphite in XRD spectrum is seen as expanded.

Raman spectrum obtained for the nitrogen-doped graphene (N-GN) is given in FIG. 4. The characteristic 1375 cm⁻¹ (D band) and 1580 cm⁻¹ (G band) peaks at Raman spectrum shows the graphene formation.

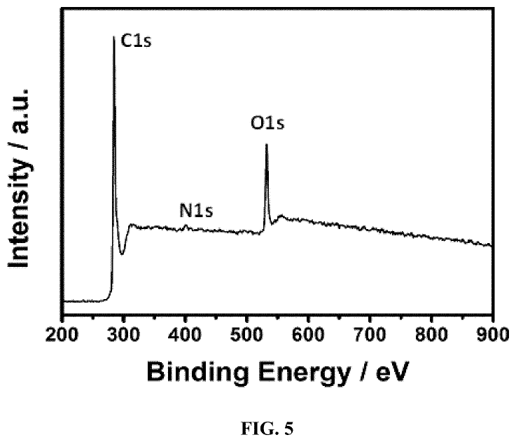

XPS spectrum obtained for the nitrogen-doped graphene (N-GN) is given in FIG. 5. It is seen in XPS spectrum that the structure consists of C (70.3% atom), N (3.6% atom) and O (22.5% atom) only.

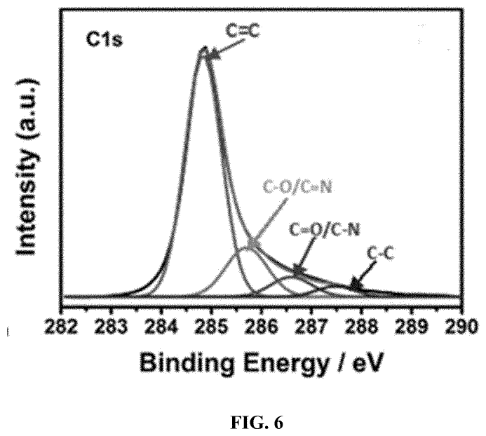

High resolution C1S-XPS spectrum for the nitrogen-doped graphene obtained by the method of the invention is given in FIG. 6. The sharp peak at 284.7 eV shows that a majority of the carbon atoms of the nitrogen-doped graphene consists of the carbon atoms having sp2 hybrid orbitals.

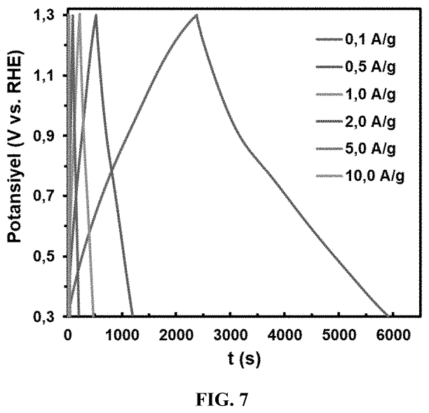

The charge-discharge curves of the N-GN electrodes obtained by the method in the two-electrode cell performed in the solution containing 3.0 M H₂SO₄ electrolyte at different current densities are given in FIG. 7.

The charge-discharge curves of the N-GN electrodes obtained in a solution comprising 6.0 M KOH electrolyte at different current densities are given in FIG. 8.

The specific capacitance (C), energy density (E), and power density (P) values calculated for N-GN based on the data from FIG. 7 and FIG. 8 are given in the following table:

| | Electrolyte | | | | | |
|---|---|---|---|---|---|---|
| | 3.0M H₂SO₄ | | | 6.0M KOH | | |
| | Specific | | | Specific | | |
| Current | Capaci- | Energy | | Capaci- | Energy | |
| Density | tance | Density | P | tance | Density | P |
| (A/g) | (F/g) | (W · g/kg) | (W/kg) | (F/g) | (W · g/kg) | (W/kg) |
| 0.1 | 353.0 | 49.0 | 50.0 | 225.3 | 31.3 | 50.0 |
| 0.5 | 335.2 | 46.5 | 250.0 | 205.9 | 28.6 | 250.0 |
| 1.0 | 252.3 | 35.0 | 500.0 | 188.3 | 26.2 | 500.0 |
| 2.0 | 221.8 | 30.8 | 1000.0 | 133.4 | 18.5 | 1000.0 |
| 5.0 | 112.0 | 15.6 | 2500.0 | 110.0 | 15.3 | 2500.0 |
| 10.0 | 92.8 | 12.9 | 5000.0 | 81.6 | 11.3 | 5000.0 |

The invention is suitable for the production in industrial scale and has high yield compared to the current methods. The nitrogen-doped graphene obtained by this method has a high electrocatalytic activity because of very high specific surface area, high electrical conductivity, and the nitrogen it contains. Also, boron-, sulfur-, silicon-, and/or iron atoms-doped graphene can be obtained by the same method and the particle size of the obtained product can be adjusted. For example, when the nitrogen-doped graphene with high electrochemical surface area is used for Li-ion batteries, higher energy density can be obtained at unit mass relative to the Li′+e⁻=LiC6 reaction, and its uniform pore structure and the ion channels provides higher power density and charge/discharge rate relative to the current materials.

The production method of the final graphene-based product into which the final organic and/or inorganic compounds of the silicon (Si), iron (Fe), and other similar elements are doped by tuning the particle size upon adjusting the pH value of the mixture within the range of 1-14 in one of the production steps after the solvothermal process of the inventive nitrogen-doped graphene comprises the following steps:
preparing the mixture by introducing 1-50% metallic sodium (Na) by mass and 50-99% N,N-dimethylformamide (DMF) by mass within a chamber having a teflon surface,
adding the organic and/or inorganic compounds of silicon (Si), iron (Fe), and other similar elements to the mixture such that their elemental ratio will be 0.1-10% of the total mass,
placing the prepared mixture into the temperature and pressure controlled solvothermal reactor,
subjecting the mixture placed into the heat- and pressure-controlled solvothermal reactor to the solvothermal process at a temperature of 70° C.-210° C. and at a reactor pressure within the range of 10 bar-90 bar for 12 hours-60 hours,
liquefying the mixture by adding purified water or mineral acid solutions such as hydrochloric acid (HCl), sulfuric acid (H₂SO₄), perchloric acid (HClO₄) such that the final pH value thereof will be within the range of 1-14,
drying the liquid mixture having a pH value within the range of 1-14 in a vacuum oven at a temperature of 80° C.-160° C.,
pyrolyzing the dried mixture in the presence of argon (Ar), nitrogen ((N₂), water (H₂O), or a combination thereof at a temperature of 450° C.-900° C. in the horizontal quartz-tube furnace,

When silicon atoms are doped to the mixture as described above, the doped silicon atoms minimize the volume expansion which occurs in the anode during discharging the Li-ion batteries and the electrode disruptions. Increased surface area and uniform pore structure enable high electrical double-layer formation and increase the energy and power densities. Also, the nitrogen atoms of the structure are subjected to the reversible redox reaction with the solvent, thereby increasing the pseudo-capacitance and thus increasing the energy density. Oxygen reduction reaction (ORR) which occurs in the cathodes of the metal-air batteries is a significant step determining the energy and power densities of these batteries. The nitrogen atoms within the product obtained by the invention enables the oxygen reduction by facilitating the adsorption of the oxygen onto the catalyst surface, thereby enabling the product to show electrocatalytic feature. The nitrogen-doped graphene may be used as the cathode electrocatalyst for the metal-air batteries through this feature thereof.

The CV voltammograms of the nitrogen-doped graphene obtained in 0.1 M KOH electrolyte saturated with 02 and Ar gases at 20 mV/s potential scan rate are given in FIG. 9. The voltammogram of the glassy carbon electrode (GCE) which is not coated with N-GN in the Ar environment is given here for comparison.

While no reduction peak is observed in the solution saturated with the argon gas in FIG. 9, the sharp reduction peak which is observed in about 0.96 V shows that the oxygen is reduced when the solution is saturated with the oxygen gas. This is a result of the electrocatalytic ORR activity of N-GN obtained by the method.

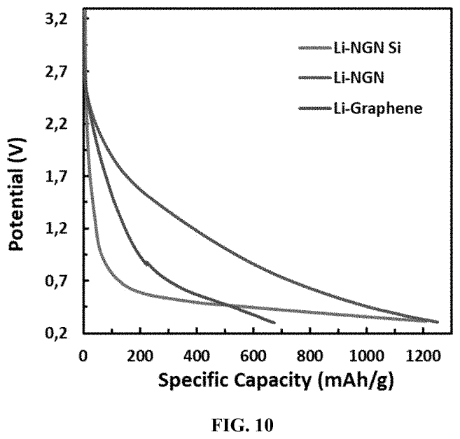

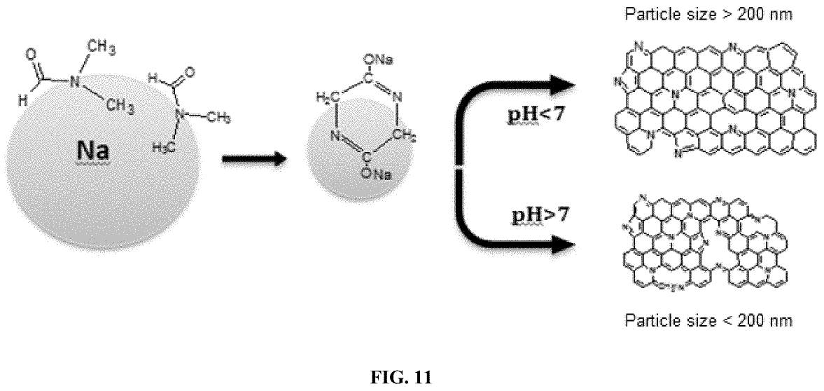

The specific capacity values of the batteries produced by using Li anode and different graphene-based cathodes obtained at a current density of 0.01 A/g are given in FIG. 10. 1.0 M LiPF₆ is used here as the electrolyte.

The Li-ion battery capacities prepared with N-GN which is produced by the method of the invention and with Si-doped N-GN are given by comparison to the commercial graphene. Accordingly, while the commercial graphene has a specific capacity of about 680 mAh/g, N-GN (Li-NGN) and Si-doped N-GN (Li-NGN Si) have specific capacities of 1240 and 1210 mAh/g respectively.

What is claimed is:

1. A production method of nitrogen-doped graphene, comprising the following steps:
preparing a first mixture by introducing 1-50% metallic sodium (Na) by mass and 50-99% N,N-dimethylformamide (DMF) by mass within a chamber having a teflon surface;
placing the first mixture into a heat- and pressure-controlled solvothermal reactor, and subjecting the first mixture to a solvothermal process at a temperature of 70° C.-210° C. and at a reactor pressure within a range of 10 bar-90 bar for 12 hours-60 hours;
liquefying the first mixture subjected to the solvothermal process by adding purified water or a mineral acid solution to the first mixture subjected to the solvothermal process to obtain a second mixture until a final pH value of the second mixture is within a range of 1-14, wherein the mineral acid solution is one or more of hydrochloric acid (HCl), sulfuric acid (H₂SO₄), and perchloric acid (HClO₄);
drying the second mixture having the pH value within the range of 1-14 in a vacuum oven at a temperature of 80° C.-160° C. to obtain a dried mixture,
pyrolyzing the dried mixture in presence of argon (Ar), nitrogen (N₂), water (H₂O), or a combination thereof at a temperature of 450° C.-900° C. in a horizontal quartz-tube furnace;
wherein a particle size of a final graphene-based product is adjusted upon adjusting the final pH value of the second mixture after the solvothermal process.

2. The production method according to claim 1, wherein organic and/inorganic compounds of silicon (Si), iron (Fe) elements are doped to the nitrogen-doped graphene, and the production method further comprises the following step:
after the first mixture is prepared and before the first mixture is placed into the heat- and pressure-controlled solvothermal reactor, adding the organic and/or inorganic compounds of silicon (Si) and iron (Fe) elements to the first mixture at an amount of 0.1-10% of a total mass.
